(19) United States
(12) Patent Application Publication
(10) Pub. No.: US 2015/0205370 A1
(43) Pub. Date: Jul. 23, 2015

(54) Method for Providing Tactile Keys for Touch-Sensitive Keyboards

(71) Applicant: Charles Albert Morris, Maquoketa, IA (US)

(72) Inventor: Charles Albert Morris, Maquoketa, IA (US)

(21) Appl. No.: 14/599,428

(22) Filed: Jan. 16, 2015

Related U.S. Application Data
(60) Provisional application No. 61/929,012, filed on Jan. 18, 2014.

(51) Int. Cl. G06F 3/02; G06F 3/041; G06F 3/0488

(52) U.S. Cl. CPC G06F 3/0227; G06F 3/04886; G06F 3/0416; G06F 3/0202

(57) ABSTRACT

Depressible home keys built into an overlay for a touch-sensitive keyboard offer rest positions for the fingers of a typist, and recesses in the overlay allow engagement of the touch sensor while providing tactile feedback to the typist when engaging non-home keys. The significant difference in elevation between the recesses and the rest of the overlay prevents accidental engagement of spaces between the keys or of multiple keys at one time. This configuration for touch-sensitive keyboards can be embodied in an overlay for a touch screen or for a tablet computer, as a stand alone keyboard, or as a stand alone keyboard that includes a touch screen that provides multiple sets of characters and/or commands to be used with specific computer programs.

### BACKGROUND OF THE INVENTION

The present invention relates to providing tactile feedback for all keys on a touch-sensitive keyboard.

Numerous embodiments of touch-sensitive keyboards exist in the prior art including ones that provide means by which the typist can push depressible keys to provide tactile point of reference and tactile feedback, including U.S. Patent Application # 20130002584 A1, U.S. Pat. No. 8,692,783 B2, U.S. Pat. No. 8,558,796 B2, U.S. Pat. No. 8,243,038, U.S. Pat. No. 6,880,998, U.S. Pat. No. 7,659,885, U.S. Pat. No. 7,403,191, U.S. Patent Application # 20100238119 A1, and U.S. Pat. No. 8,206,047 B1. However, none of these keyboards take advantage of the lighter touch that touch-sensitive surfaces and touch screens afford, and instead force the user to push every key. Furthermore, none of these solutions prevent the inadvertent engagement of multiple keys.

Other embodiments of touch-sensitive keyboards exist in the prior art that include overlays with recesses or holes in the overlay positioned above the keys of the keyboard, as in U.S. Pat. No. 8,692,783 and U.S. Patent Application # 20130079139 A1, but such embodiments require the user to keep his or her hands elevated above the overlay, because they do not provide rest positions for the fingers.

My U.S. Pat. No. 6,869,289 introduced the concept of depressible keys in the home row in an otherwise touch-sensitive keyboard. The current patent application extends that principle by uniquely addressing the need for tactile feedback for all keys and the need to prevent inadvertent multi-key strikes.

It would be advantageous to provide an overlay for touch-sensitive keyboards, including touch screens, that incorporates depressible home keys allowing users to rest their fingers and maintain an overall tactile sense of the keyboard's placement and incorporates depressions in the overlay for all other keys. These depressions allow engagement of the touch-sensitive surface below the overlay and provide tactile feedback as the user engages all non-home keys. In this way, we take advantage of the lighter touch we have come to expect from touch screens, while maintaining overall sensory awareness of all keys, allowing typists to touch type without looking at the keys. Furthermore, the raised elevation of the overlay where there are no depressions prevents accidental engagement of spaces between the keys or of multiple keys at one time.

### BRIEF SUMMARY OF THE INVENTION

It is an object of the invention to provide a tactile overlay for a touch-sensitive keyboard including eight depressible home keys for the fingers and depressions in the overlay for all non-depressible keys. The overlay prevents engagement of the touch-sensitive keyboard where there are no depressions or depressible keys in the overlay and prevents the accidental engagement of multiple keys at one time.

It is a further object of the invention to provide a modified form of construction which includes a transparent tactile overlay for a touch-sensitive screen that provides eight depressible transparent dome home keys for the fingers, two depressible transparent dome home keys for the thumb, and depressions in the overlay for all non-depressible keys. Ends of the overlay with a micro-suction bottom surface keep the overlay in position over the onscreen virtual keyboard. The overlay prevents engagement of the touch-sensitive screen where there are no depressions or depressible keys in the overlay and prevents the accidental engagement of multiple keys at one time.

It is a further object of the invention to provide a modified form of construction which includes a transparent tactile overlay for the touch-sensitive screen of a tablet computer that provides eight depressible transparent dome home keys for the fingers, one depressible transparent elongated dome home key for the thumbs, and depressions in the overlay for all non-depressible keys. In this form of construction, the left and right halves of the overlay are set at an oblique angle relative to one another. The overlay prevents engagement of the touch-sensitive screen where there are no depressions or depressible keys in the overlay and prevents the accidental engagement of multiple keys at one time. The edges of the overlay are formed to bend around the edges of the tablet computer to keep the overlay in position on the tablet computer.

It is a further object of the invention to provide a modified form of construction which includes a transparent tactile overlay for the touch-sensitive screen of a smart phone that provides four depressible transparent dome home keys for the fingers, one depressible transparent dome home key for a thumb, and depressions in the overlay for all non-depressible keys. The overlay prevents engagement of the touch-sensitive screen where there are no depressions or depressible keys in the overlay and prevents the accidental engagement of multiple keys at one time. The edges of the overlay are formed to bend around the edges of the smart phone to keep the overlay in position on the smart phone.

It is a further object of the invention to provide a modified form of construction which includes a keyboard that has a convexly arced shape with the left and right halves of the keys spatially separated from one another to make room for a 3D sensor built into the middle of the keyboard.

It is a further object of the invention to provide a modified form of construction which includes an inflatable and deflatable tactile overlay that is permanently attached to a touch screen, providing eight depressible home keys for the fingers, two depressible home key for the thumbs, depressions in the overlay for all non-home keys, and a raised surface surrounding all keys. The raised surface surrounding all keys, the sloping sides of the depressions, and the raised and depressible home keys all can be deflated to lay flat against the touch screen. The overlay prevents engagement of the touch screen where there are no depressions or depressible keys in the overlay and prevents the accidental engagement of multiple keys at one time.

It is a further object of the invention to provide a modified form of construction which includes a transparent tactile overlay for a tablet computer that provides eight depressible transparent dome home keys for the fingers, two depressible transparent dome home keys for the thumbs, and depressions in the overlay for all non-depressible keys. In this form of construction, the overlay is built into a removable screen cover for the tablet computer. The overlay prevents engagement of the tablet's touch screen where there are no depressions or depressible keys in the overlay and prevents the accidental engagement of multiple keys at one time.

It is a further object of the invention to provide a modified form of construction which includes a transparent tactile overlay that provides eight depressible transparent dome home keys for the fingers, two depressible transparent dome home keys for the thumbs, and depressions in the overlay for all non-depressible keys. This transparent tactile overlay is permanently affixed to a touch sensitive screen built into the horizontal portion of a laptop computer. Variable sets of characters and commands can be chosen to appear on the horizontal touch sensitive screen so it can be used as a data input keyboard for various programs running on the laptop computer. The overlay prevents engagement of the touch-sensitive screen where there are no depressions or depressible keys in the overlay and prevents the accidental engagement of multiple keys at one time.

It is a further object of the invention to provide a modified form of construction that includes a tactile overlay for a touch-sensitive keyboard that provides eight depressible dome home keys for the fingers, one depressible elongated dome home key for the thumbs, and depressions in the overlay for all non-depressible keys. In this form of construction, the left and right halves of the keys are set at an oblique angle relative to one another and are separated to make room for an elevated touch-sensitive platform. The overlay prevents engagement of the touch-sensitive screen where there are no depressions or depressible keys in the overlay and prevents the accidental engagement of multiple keys at one time.

### BRIEF DESCRIPTION OF THE SEVERAL VIEWS OF THE DRAWING

The present invention will be more fully understood by reference to the following detailed descriptions thereof when read in conjunction with the attached drawings, and wherein:

FIG. 1 is a perspective view of a preferred embodiment of the keyboard in accordance with the present invention in which a tactile overlay for a touch-sensitive keyboard includes eight depressible home keys for the fingers and depressions in the overlay for all non-depressible keys; and

FIG. 2 is a perspective view of a modified form of construction of the keyboard in accordance with the present invention in which a transparent tactile overlay for a touch-sensitive screen provides eight depressible transparent dome home keys for the fingers, two depressible transparent dome home keys for the thumbs, and depressions in the overlay for all non-depressible keys. Ends of the overlay with a micro-suction bottom surface keep the overlay in position over the onscreen virtual keyboard; and

FIG. 3 is a perspective view of a further modified form of construction of the keyboard in accordance with the present invention in which a transparent tactile overlay for the touch-sensitive screen of a tablet computer provides eight depressible transparent dome home keys for the fingers, one depressible transparent elongated dome home key for the thumbs, and depressions in the overlay for all non-depressible keys. In this form of construction, the left and right halves of the overlay are set at an oblique angle relative to one another. The edges of the overlay are formed to bend around the edges of the tablet computer to keep the overlay in position on the tablet computer; and

FIG. 4 is a perspective view of a still further modified form of construction of the keyboard in accordance with the present invention in which a transparent tactile overlay for the touch-sensitive screen of a smart phone provides four depressible transparent dome home keys for the fingers, one depressible transparent dome home key for a thumb, and depressions in the overlay for all non-depressible keys. The edges of the overlay are formed to bend around the edges of the smart phone to keep the overlay in position on the smart phone, and

FIG. 5 is a perspective view of an even still further modified form of construction of the keyboard in accordance with the present invention in which the keyboard has a convexly arced shape with the left and right halves of the keys spatially separated from one another to make room for a 3D sensor built into the middle of the keyboard that can track the motion of the fingers and hands of a user in the space above said touch screen for the purpose of providing interactive control in mid-air of a computerized device; and

FIG. 6 is a perspective view of an even yet still further modified form of construction of the keyboard in accordance with the present invention in which an inflatable and deflatable tactile overlay is permanently attached to a touch screen, providing eight depressible home keys for the fingers, two depressible home key for the thumbs, and depressions in the overlay for all non-home keys. The raised surface surrounding all keys and the raised and depressible home keys all can be deflated to lay flat against the touch screen; and

FIG. 7 is a perspective view of the form of construction of the keyboard shown in FIG. 6 in which the inflatable and deflatable tactile overlay is shown deflated. The raised surface of the tactile overlay surrounding all keys as well as the dome home keys are shown deflated to lay flat against the touch-sensitive screen; and

FIG. 8 is a perspective view of a even yet further still modified form of construction of the keyboard in accordance with the present invention in which a transparent tactile overlay for a tablet computer provides eight depressible transparent dome home keys for the fingers, two depressible transparent dome home keys for the thumbs, and depressions in the overlay for all non-depressible keys. In this form of construction, the overlay is built into a removable screen cover for the tablet computer; and

FIG. 9 is a perspective view of a even further modified form of construction of the keyboard in accordance with the present invention in which a transparent tactile overlay provides eight depressible transparent dome home keys for the fingers, one depressible transparent dome home key for a thumb, and depressions in the overlay for all non-depressible keys, including an elongated depression in the overlay for a non-depressible touch-sensitive key for a thumb that allows a thumb of the typist to move back and forth across its elongated depressed surface to scroll through and select alternate sets of data input commands that then appear on the touch-sensitive screen. The transparent tactile overlay is permanently affixed to a touch sensitive screen built into the horizontal portion of a laptop computer. Variable sets of characters and commands can be chosen to appear on the horizontal touch sensitive screen so it can be used as a data input keyboard for various programs running on the laptop computer; and

FIG. 10 is a perspective view of a yet even still further modified form of construction of the keyboard in accordance with the present invention in which a tactile overlay for the keyboard provides eight depressible dome home keys for the fingers, one depressible elongated dome home key for the thumbs, and depressions in the overlay for all non-depressible keys. In this form of construction, the left and right halves of the overlay are set at an oblique angle relative to one another and are separated to make room for an elevated touch-sensitive platform.

### DETAILED DESCRIPTION OF THE INVENTION

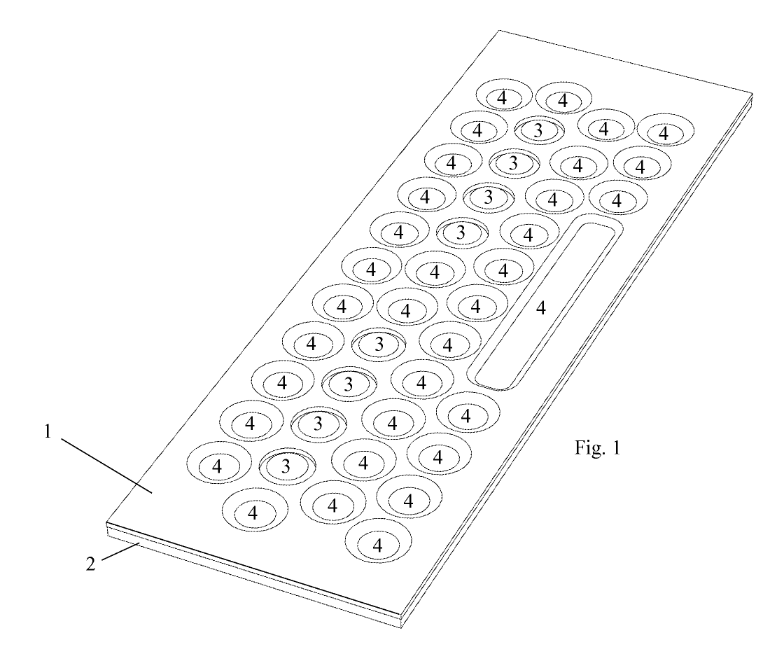

In FIG. 1, there is shown a perspective view of a preferred embodiment of the keyboard in accordance with the present invention in which a tactile overlay 1 for a touch-sensitive keyboard 2 includes eight depressible home keys for the fingers 3 and depressions in the overlay 1 for all non-depressible keys 4. The tactile overlay 1 prevents engagement of the touch-sensitive keyboard 2 where there are no depressions or depressible keys in the tactile overlay 1 and prevents the accidental engagement of multiple keys at one time. Many different approaches could be taken to achieve satisfactory results in the production of the tactile overlay 1, including the following: Thermoformed semi-rigid plastic or injection molded plastic that creates an air gap between the plastic and the touch sensor except where the non-depressible keys 4 are, and has holes where the dome shaped depressible home keys 3 are, and has thin sheet(s) of thermoformed flexible plastic that form the dome shaped depressible home keys 3. Thermoformed semi-rigid plastic or injection molded plastic that creates an air gap between the plastic and the touch sensor except where the non-depressible keys 4 are, with holes where the dome shaped depressible home keys 3 are, and with silicone dome depressible home keys 3. Thermoformed flexible plastic like HDPE that creates an air gap between the plastic and the touch sensor except where the keys are. Machined plastic thick enough to prevent engagement of the touch sensor, with holes machined out for all keys, and with thin sheet(s) of thermoformed flexible plastic for dome shaped depressible home keys 3. Machined plastic thick enough to prevent engagement of the touch sensor, with holes machined out for all keys, and with silicone dome depressible home keys 3. Injection-molded plastic thick enough to prevent engagement of the touch sensor except where the keys are, with silicone dome depressible home keys 3. Injection-molded plastic thick enough to prevent engagement of the touch sensor except where the keys are, with holes left for all keys, and with a secondary thin sheet of thermoformed flexible plastic for dome shaped depressible home keys 3. However, it cannot be said that there is one best method for achieving the overlay 1 as all of these approaches have their benefits and drawbacks; and

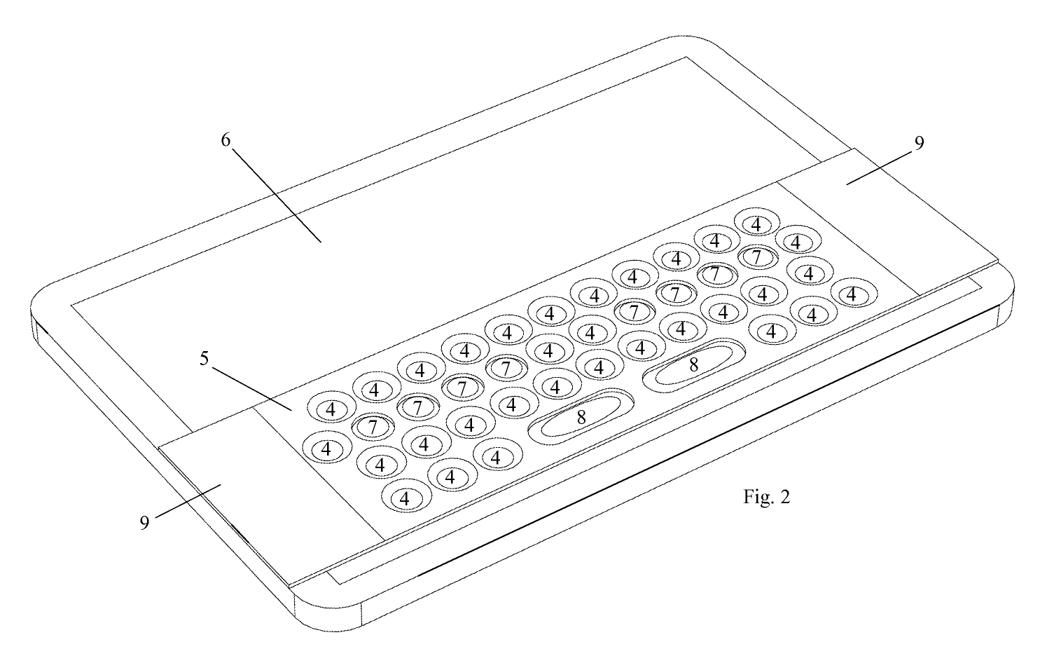

In FIG. 2, there is shown a perspective view of a modified form of construction of the keyboard in accordance with the present invention in which a transparent tactile overlay 5 for a touch-sensitive screen 6 provides eight depressible transparent home keys for the fingers 7, two depressible transparent home keys for the thumbs 8, and depressions in the overlay 5 for all non-depressible keys 4. The tactile overlay 5 prevents engagement of the touch-sensitive screen 6 where there are no depressions or depressible keys in the tactile overlay 5 and prevents the accidental engagement of multiple keys at one time. Ends of the overlay with a micro-suction bottom surface 9 keep the transparent tactile overlay 5 in position on the touch-sensitive screen 6. Many different approaches could be taken to achieve satisfactory results in the production of the tactile overlay 5, including the following: Thermoformed semi-rigid plastic or injection molded plastic that creates an air gap between the plastic and the touch-sensitive screen 6 except where the non-depressible keys 4 are, and has holes where the dome shaped depressible home keys 7 and 8 are, and has thin sheet(s) of thermoformed flexible plastic that form the dome shaped depressible home keys 7 and 8. Thermoformed semi-rigid plastic or injection molded plastic that creates an air gap between the plastic and the touch-sensitive screen 6 except where the non-depressible keys 4 are, with holes where the dome shaped depressible home keys 7 and 8 are, and with silicone dome depressible home keys 7 and 8. Thermoformed flexible plastic like HDPE that creates an air gap between the plastic and the touch-sensitive screen 6 except where the keys are. Machined plastic thick enough to prevent engagement of the touch-sensitive screen 6, with holes machined out for all keys, and with thin sheet(s) of thermoformed flexible plastic for dome shaped depressible home keys 7 and 8. Machined plastic thick enough to prevent engagement of the touch-sensitive screen 6, with holes machined out for all keys, and with silicone dome depressible home keys 7 and 8. Injection-molded plastic thick enough to prevent engagement of the touch-sensitive screen 6 except where the keys are, with silicone dome depressible home keys 7 and 8. Injection-molded plastic thick enough to prevent engagement of the touch-sensitive screen 6 except where the keys are, with holes left for all keys, and with a secondary thin sheet of thermoformed flexible plastic for dome shaped depressible home keys 7 and 8. However, it cannot be said that there is one best method for achieving the overlay 5 as all of these approaches have their benefits and drawbacks; and

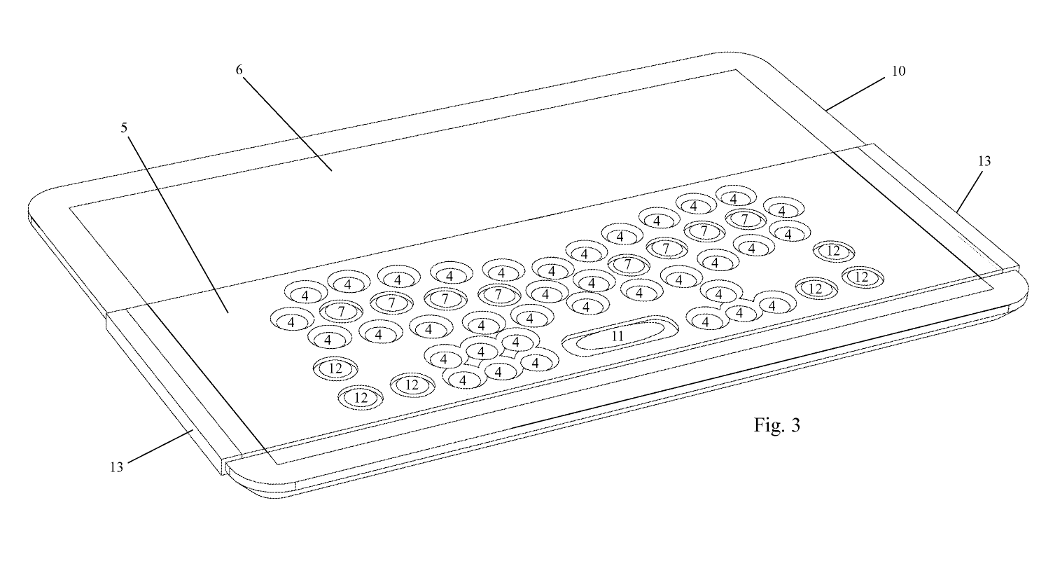

In FIG. 3, there is shown a perspective view of a further modified form of construction of the keyboard in accordance with the present invention in which a transparent tactile overlay 5 for the touch-sensitive screen 6 of a tablet computer 10 provides eight depressible transparent home keys for the fingers 7, one depressible transparent elongated home key for the thumbs 11, depressions in the overlay for all non-depressible keys 4, and six depressible transparent command keys 12. In this form of construction, the left and right halves of the keys are set at an oblique angle relative to one another. The tactile overlay 5 prevents engagement of the touch-sensitive screen 6 where there are no depressions or depressible keys in the transparent tactile overlay 5 and prevents the accidental engagement of multiple keys at one time. The edges 13 of the transparent tactile overlay 5 are formed to bend around the edges of the tablet computer 10 to keep the transparent tactile overlay 5 in position on the tablet computer 10. Many different approaches could be taken to achieve satisfactory results in the production of the tactile overlay 5, including the following: Thermoformed semi-rigid plastic or injection molded plastic that creates an air gap between the plastic and the touch-sensitive screen 6 except where the non-depressible keys 4 are, and has holes where the dome shaped depressible keys 7, 11, and 12 are, and has thin sheet(s) of thermoformed flexible plastic that form the dome shaped depressible keys 7, 11, and 12. Thermoformed semi-rigid plastic or injection molded plastic that creates an air gap between the plastic and the touch-sensitive screen 6 except where the non-depressible keys 4 are, with holes where the dome shaped depressible keys 7, 11, and 12 are, and with silicone dome depressible keys 7, 11, and 12. Thermoformed flexible plastic like HDPE that creates an air gap between the plastic and the touch-sensitive screen 6 except where the keys are. Machined plastic thick enough to prevent engagement of the touch-sensitive screen 6, with holes machined out for all keys, and with thin sheet(s) of thermoformed flexible plastic for dome shaped depressible keys 7, 11, and 12. Machined plastic thick enough to prevent engagement of the touch-sensitive screen 6, with holes machined out for all keys, and with silicone dome depressible keys 7, 11, and 12. Injection-molded plastic thick enough to prevent engagement of the touch-sensitive screen 6 except where the keys are, with silicone dome keys 7, 11, and 12. Injection-molded plastic thick enough to prevent engagement of the touch-sensitive screen 6 except where the keys are, with holes left for all keys, and with a secondary thin sheet of thermoformed flexible plastic for dome shaped depressible keys 7, 11, and 12. However, it cannot be said that there is one best method for achieving the overlay 5 as all of these approaches have their benefits and drawbacks; and

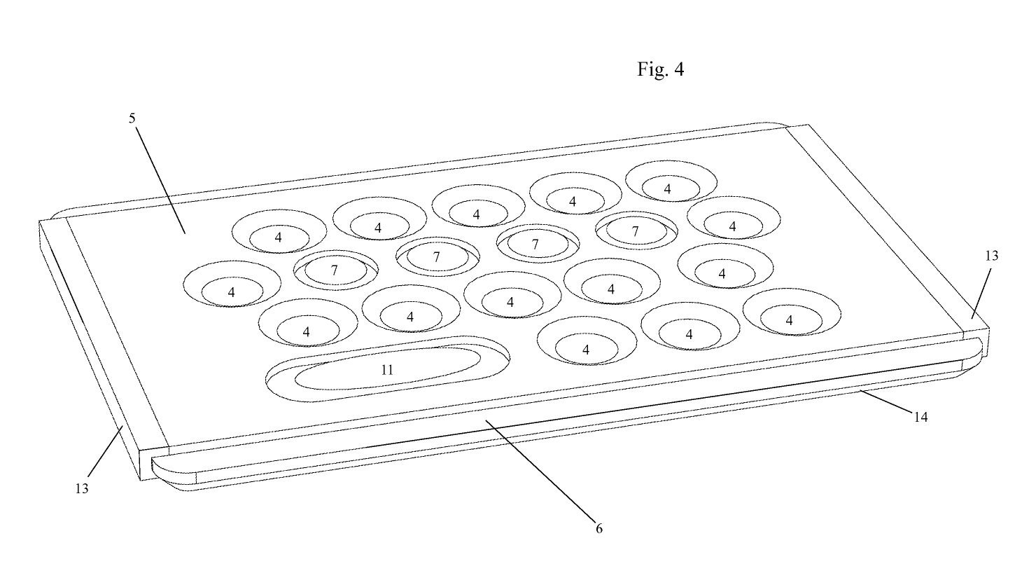

In FIG. 4, there is shown a perspective view of a still further modified form of construction of the keyboard in accordance with the present invention in which a transparent tactile overlay 5 for the touch-sensitive screen 6 of a smart phone 14 provides four depressible transparent home keys for the fingers 7, one depressible transparent home key for a thumb 11, and depressions in the overlay for all non-depressible keys 4. The transparent tactile overlay 5 prevents engagement of the touch-sensitive screen 6 where there are no depressions or depressible keys in the transparent tactile overlay 5 and prevents the accidental engagement of multiple keys at one time. The edges 13 of the transparent tactile overlay 5 are formed to bend around the edges of the smart phone 14 to keep the transparent tactile overlay 5 in position on the smart phone 14. Many different approaches could be taken to achieve satisfactory results in the production of the tactile overlay 5, including the following: Thermoformed semi-rigid plastic or injection molded plastic that creates an air gap between the plastic and the touch-sensitive screen 6 except where the non-depressible keys 4 are, and has holes where the dome shaped depressible home keys 7 and 11 are, and has thin sheet(s) of thermoformed flexible plastic that form the dome shaped depressible home keys 7 and 11. Thermoformed semi-rigid plastic or injection molded plastic that creates an air gap between the plastic and the touch-sensitive screen 6 except where the non-depressible keys 4 are, with holes where the dome shaped depressible home keys 7 and 11 are, and with silicone dome depressible home keys 7 and 11. Thermoformed flexible plastic like HDPE that creates an air gap between the plastic and the touch-sensitive screen 6 except where the keys are. Machined plastic thick enough to prevent engagement of the touch-sensitive screen 6, with holes machined out for all keys, and with thin sheet(s) of thermoformed flexible plastic for dome shaped depressible home keys 7 and 11. Machined plastic thick enough to prevent engagement of the touch-sensitive screen 6, with holes machined out for all keys, and with silicone dome depressible home keys 7 and 11. Injection-molded plastic thick enough to prevent engagement of the touch-sensitive screen 6 except where the keys are, with silicone dome depressible home keys 7 and 11. Injection-molded plastic thick enough to prevent engagement of the touch-sensitive screen 6 except where the keys are, with holes left for all keys, and with a secondary thin sheet of thermoformed flexible plastic for dome shaped depressible home keys 7 and 11. However, it cannot be said that there is one best method for achieving the overlay 5 as all of these approaches have their benefits and drawbacks; and

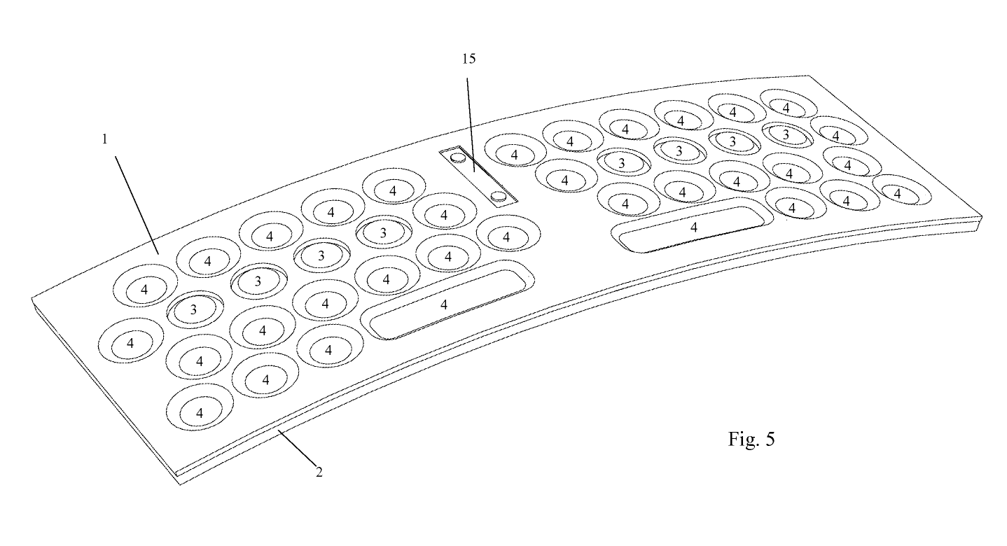

In FIG. 5, there is shown a perspective view of an even still further modified form of construction of the keyboard in accordance with the present invention in which a tactile overlay 1 for a touch-sensitive keyboard 2 includes eight depressible home keys for the fingers 3 and depressions in the overlay 1 for all non-depressible keys 4. The tactile overlay 1 prevents engagement of the touch-sensitive keyboard 2 where there are no depressions or depressible keys in the tactile overlay 1 and prevents the accidental engagement of multiple keys at one time. In this form of construction, the keyboard 2 has a convexly arced shape with the left and right halves of the keys spatially separated from one another to make room for a 3D sensor 15 built into the middle of the keyboard 2 that can track the motion of the fingers of a user in the space above said touch screen for the purpose of providing interactive control in mid-air of a computerized device. Many different approaches could be taken to achieve satisfactory results in the production of the tactile overlay 1, including the following: Thermoformed semi-rigid plastic or injection molded plastic that creates an air gap between the plastic and the touch sensor except where the non-depressible keys 4 are, and has holes where the dome shaped depressible home keys 3 are, and has thin sheet(s) of thermoformed flexible plastic that form the dome shaped depressible home keys 3. Thermoformed semi-rigid plastic or injection molded plastic that creates an air gap between the plastic and the touch sensor except where the non-depressible keys 4 are, with holes where the dome shaped depressible home keys 3 are, and with silicone dome depressible home keys 3. Thermoformed flexible plastic like HDPE that creates an air gap between the plastic and the touch sensor except where the keys are. Machined plastic thick enough to prevent engagement of the touch sensor, with holes machined out for all keys, and with thin sheet(s) of thermoformed flexible plastic for dome shaped depressible home keys 3. Machined plastic thick enough to prevent engagement of the touch sensor, with holes machined out for all keys, and with silicone dome depressible home keys 3. Injection-molded plastic thick enough to prevent engagement of the touch sensor except where the keys are, with silicone dome depressible home keys 3. Injection-molded plastic thick enough to prevent engagement of the touch sensor except where the keys are, with holes left for all keys, and with a secondary thin sheet of thermoformed flexible plastic for dome shaped depressible home keys 3. However, it cannot be said that there is one best method for achieving the overlay 1 as all of these approaches have their benefits and drawbacks; and

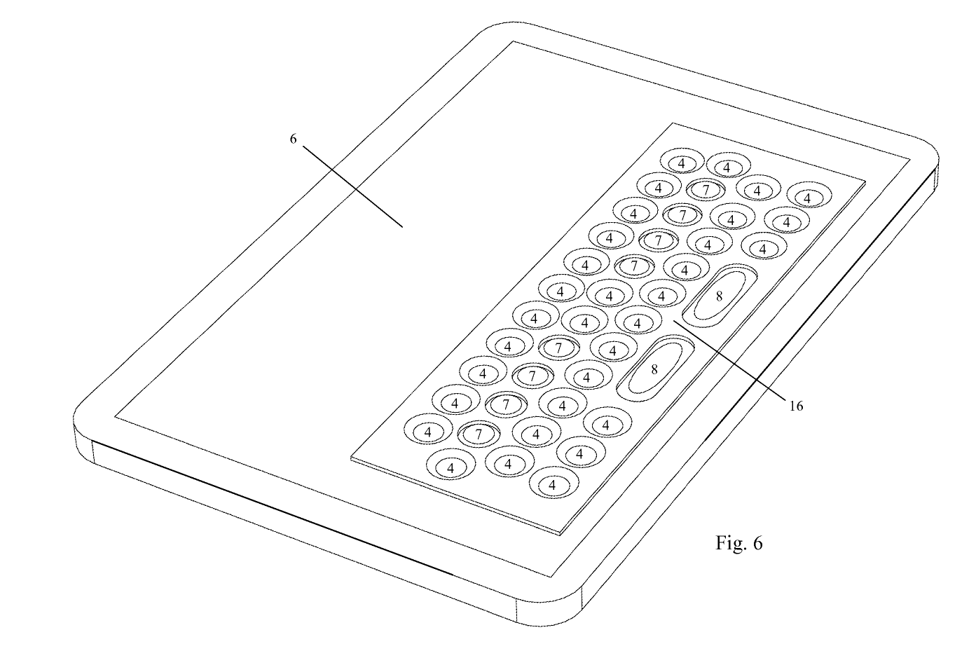

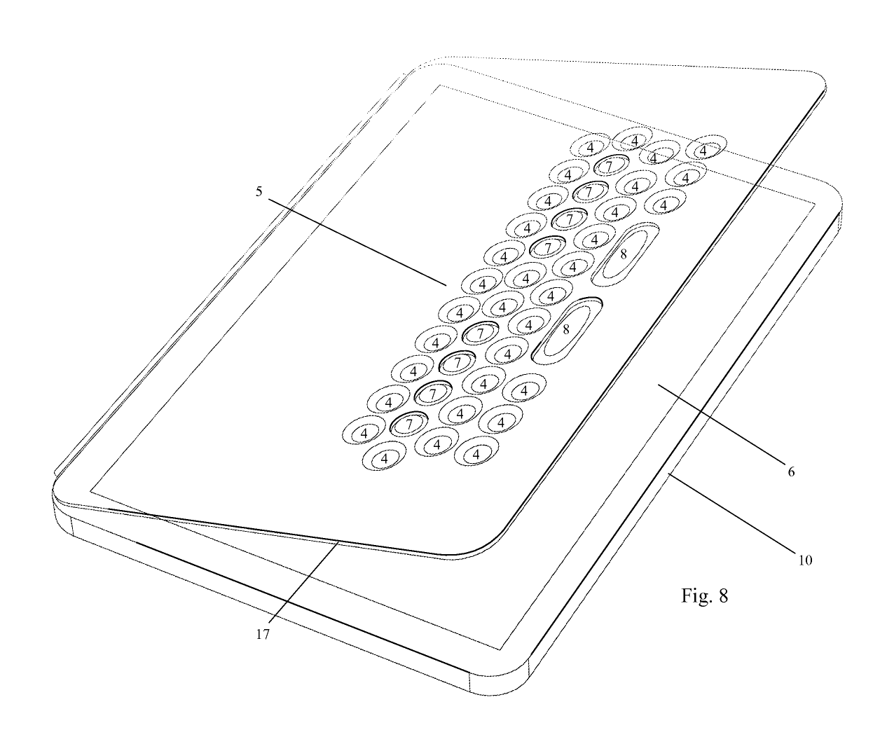

In FIG. 6, there is shown a perspective view of an even yet still further modified form of construction of the keyboard in accordance with the present invention in which an inflatable and deflatable tactile overlay 18 is permanently attached to a touch-sensitive screen 6, providing eight depressible transparent home keys for the fingers 7, two depressible transparent home keys for the thumbs 8, and depressions in the tactile overlay 16 for all non-depressible keys 4. The tactile overlay 18 prevents engagement of the touch-sensitive screen 6 where there are no depressions or depressible keys in the tactile overlay 16 and prevents the accidental engagement of multiple keys at one time. The raised surfaces of the tactile overlay 18 surrounding the depressions for all non-depressible keys 4 as well as the transparent home keys 7 and 8 can all be deflated to lay flat against the touch-sensitive screen 6 as shown in FIG. 8. For this form of construction of the keyboard, it would be best to use the inflatable and deflatable Tactile Layer technology created by Tactus Technology of Freemont, Calif.; and

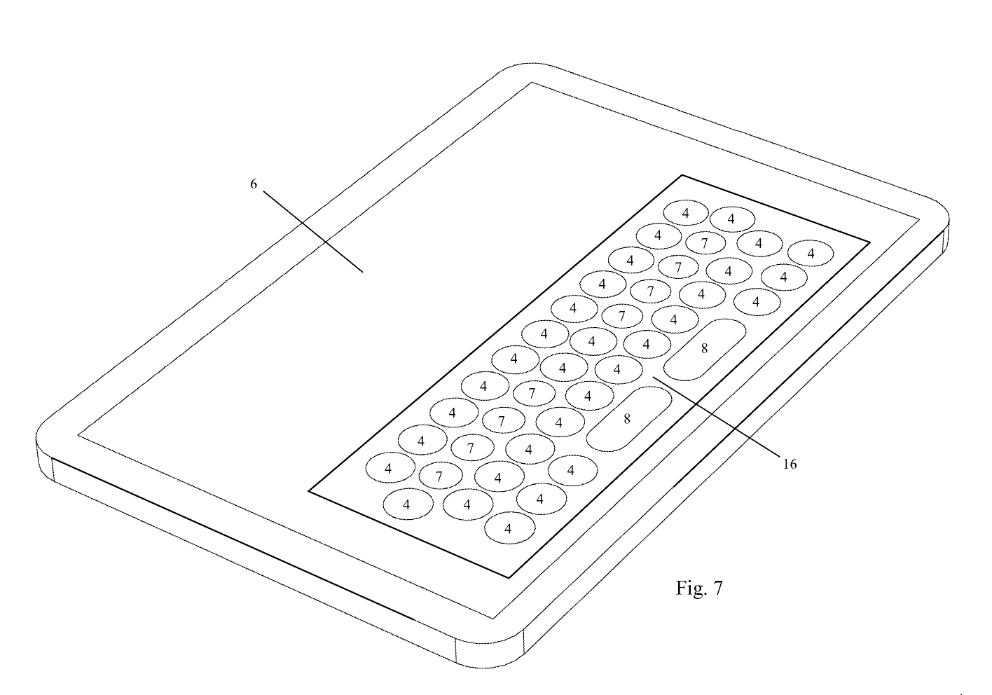

In FIG. 7, there is shown a perspective view of the form of construction of the keyboard shown in FIG. 6 in which the inflatable and deflatable transparent tactile overlay 16 is shown deflated. The raised surfaces of the transparent tactile overlay 16 surrounding the depressions for all non-depressible keys 4 as well as the transparent home keys 7 and 8 are all shown deflated, laying flat against the touch-sensitive screen 6; and

In FIG. 8, there is shown a perspective view of an even yet further still modified form of construction of the keyboard in accordance with the present invention in which a transparent tactile overlay 5 for a tablet computer 10 provides eight depressible transparent home keys for the fingers 7, two depressible transparent home keys for the thumbs 8, and depressions in the overlay 5 for all non-depressible keys 4. The tactile overlay 5 prevents engagement of the touch-sensitive screen 6 of the tablet computer 10 where there are no depressions or depressible keys in the tactile overlay 5 and prevents the accidental engagement of multiple keys at one time. In this form of construction, the overlay 5 is built into a removable screen cover 17 for the tablet computer 10, and in this perspective view the removable screen cover 17 is shown lifted off of the tablet computer 10. Many different approaches could be taken to achieve satisfactory results in the production of the tactile overlay 5, including the following: Thermoformed semi-rigid plastic or injection molded plastic that creates an air gap between the plastic and the touch-sensitive screen 6 except where the non-depressible keys 4 are, and has holes where the dome shaped depressible home keys 7 and 8 are, and has thin sheet(s) of thermoformed flexible plastic that form the dome shaped depressible home keys 7 and 8. Thermoformed semi-rigid plastic or injection molded plastic that creates an air gap between the plastic and the touch-sensitive screen 6 except where the non-depressible keys 4 are, with holes where the dome shaped depressible home keys 7 and 8 are, and with silicone dome depressible home keys 7 and 8. Thermoformed flexible plastic like HDPE that creates an air gap between the plastic and the touch-sensitive screen 6 except where the keys are. Machined plastic thick enough to prevent engagement of the touch-sensitive screen 6, with holes machined out for all keys, and with thin sheet(s) of thermoformed flexible plastic for dome shaped depressible home keys 7 and 8. Machined plastic thick enough to prevent engagement of the touch-sensitive screen 6, with holes machined out for all keys, and with silicone dome depressible home keys 7 and 8. Injection-molded plastic thick enough to prevent engagement of the touch-sensitive screen 6 except where the keys are, with silicone dome depressible home keys 7 and 8. Injection-molded plastic thick enough to prevent engagement of the touch-sensitive screen 6 except where the keys are, with holes left for all keys, and with a secondary thin sheet of thermoformed flexible plastic for dome shaped depressible home keys 7 and 8. However, it cannot be said that there is one best method for achieving the overlay 5 as all of these approaches have their benefits and drawbacks; and

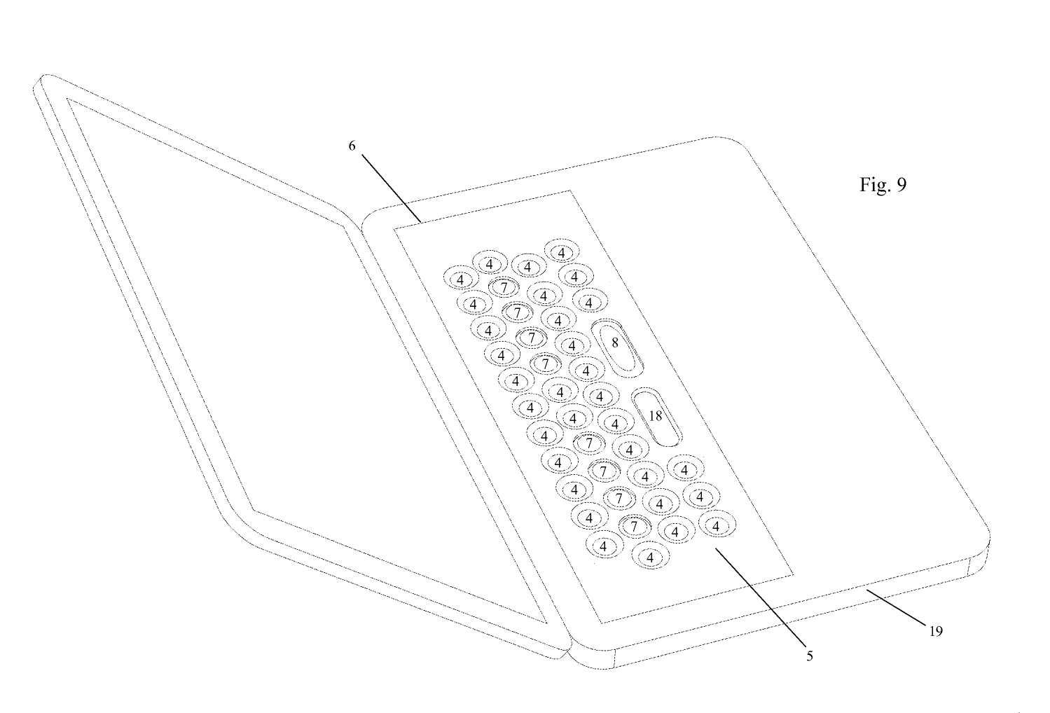

In FIG. 9, there is shown a perspective view of a still even yet further modified form of construction of the keyboard in accordance with the present invention in which a transparent tactile overlay 5 provides eight depressible transparent home keys for the fingers 7, one depressible transparent home key for a thumb 8, and depressions in the overlay 5 for all non-depressible keys 4, including an elongated depression in the overlay 5 for a non-depressible touch-sensitive key for a thumb 18 that allows a thumb of the typist to move back and forth across its elongated depressed surface to scroll through and select alternate sets of data input commands that then appear on the touch-sensitive screen 6. The transparent tactile overlay 5 is permanently affixed to a touch sensitive screen 6 built into the horizontal portion of a laptop computer 19. The tactile overlay 5 prevents engagement of the touch-sensitive screen 6 where there are no depressions or depressible keys in the tactile overlay 5 and prevents the accidental engagement of multiple keys at one time. Variable sets of characters and commands can be chosen to appear on the horizontal touch-sensitive screen 6 so it can be used as a data input keyboard for various programs running on the laptop computer 19. Many different approaches could be taken to achieve satisfactory results in the production of the tactile overlay 5, including the following: Thermoformed semi-rigid plastic or injection molded plastic that creates an air gap between the plastic and the touch-sensitive screen 6 except where the non-depressible keys 4 and 18 are, and has holes where the dome shaped depressible home keys 7 and 8 are, and has thin sheet(s) of thermoformed flexible plastic that form the dome shaped depressible home keys 7 and 8. Thermoformed semi-rigid plastic or injection molded plastic that creates an air gap between the plastic and the touch-sensitive screen 6 except where the non-depressible keys 4 and 18 are, with holes where the dome shaped depressible home keys 7 and 8 are, and with silicone dome depressible home keys 7 and 8. Thermoformed flexible plastic like HDPE that creates an air gap between the plastic and the touch-sensitive screen 6 except where the keys are. Machined plastic thick enough to prevent engagement of the touch-sensitive screen 6, with holes machined out for all keys, and with thin sheet(s) of thermoformed flexible plastic for dome shaped depressible home keys 7 and 8. Machined plastic thick enough to prevent engagement of the touch-sensitive screen 6, with holes machined out for all keys, and with silicone dome depressible home keys 7 and 8. Injection-molded plastic thick enough to prevent engagement of the touch-sensitive screen 6 except where the keys are, with silicone dome depressible home keys 7 and 8. Injection-molded plastic thick enough to prevent engagement of the touch-sensitive screen 6 except where the keys are, with holes left for all keys, and with a secondary thin sheet of thermoformed flexible plastic for dome shaped depressible home keys 7 and 8. However, it cannot be said that there is one best method for achieving the overlay 5 as all of these approaches have their benefits and drawbacks; and

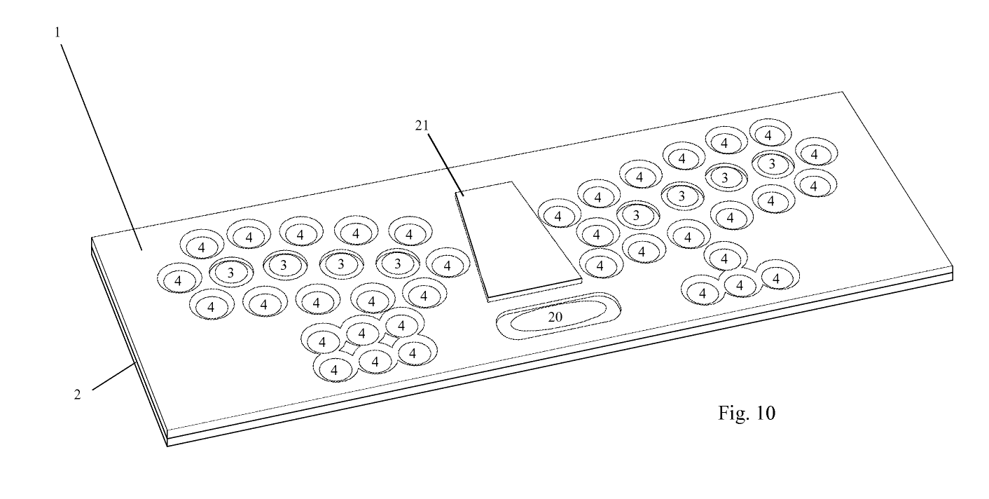

In FIG. 10, there is shown a perspective view of a yet even still further modified form of construction of the keyboard in accordance with the present invention in which a tactile overlay 1 for a touch-sensitive keyboard 2 provides eight depressible home keys for the fingers 3, one depressible elongated dome home key for the thumbs 20, and depressions in the overlay for all non-depressible keys 4. The tactile overlay 1 prevents engagement of the touch-sensitive keyboard 2 where there are no depressions or depressible keys in the tactile overlay 1 and prevents the accidental engagement of multiple keys at one time. In this form of construction, the left and right halves of the keys are set at an oblique angle relative to one another and are separated to make room for an elevated touch-sensitive platform 21. Many different approaches could be taken to achieve satisfactory results in the production of the tactile overlay 1, including the following: Thermoformed semi-rigid plastic or injection molded plastic that creates an air gap between the plastic and the touch sensor except where the non-depressible keys 4 are, and has holes where the dome shaped depressible home keys 3 and 20 are, and has thin sheet(s) of thermoformed flexible plastic that form the dome shaped depressible home keys 3 and 20. Thermoformed semi-rigid plastic or injection molded plastic that creates an air gap between the plastic and the touch sensor except where the non-depressible keys 4 are, with holes where the dome shaped depressible home keys 3 and 20 are, and with silicone dome depressible home keys 3 and 20. Thermoformed flexible plastic like HDPE that creates an air gap between the plastic and the touch sensor except where the keys are. Machined plastic thick enough to prevent engagement of the touch sensor, with holes machined out for all keys, and with thin sheet(s) of thermoformed flexible plastic for dome shaped depressible home keys 3 and 20. Machined plastic thick enough to prevent engagement of the touch sensor, with holes machined out for all keys, and with silicone dome depressible home keys 3 and 20. Injection-molded plastic thick enough to prevent engagement of the touch sensor except where the keys are, with silicone dome depressible home keys 3 and 20. Injection-molded plastic thick enough to prevent engagement of the touch sensor except where the keys are, with holes left for all keys, and with a secondary thin sheet of thermoformed flexible plastic for dome shaped depressible home keys 3 and 20. However, it cannot be said that there is one best method for achieving the overlay 1 as all of these approaches have their benefits and drawbacks.

I claim:

1. A keyboard for data input including in combination:
a proximity touch-sensor layer;
an overlay on top of said proximity touch-sensor layer that prevents engagement of said proximity touch-sensor layer where there are no depressions or depressible keys in said overlay;
at least one depressible home key housed within said overlay that must be depressed in order to actuate a corresponding area of said proximity touch-sensor layer dedicated to the engagement of a particular data input command;
more than one depression in said overlay that allows engagement of said proximity touch-sensor layer, each said depression corresponding to an area of said proximity touch-sensor layer dedicated to the engagement of a particular data input command;
and
means for coupling said proximity touch-sensor layer with a processing device.

2. The combination according to claim 1 wherein two rows of four said depressible home keys are provided for eight fingers of a typist;
and wherein at least one depressible home key is provided for at least one thumb of said typist;
and wherein said depressions in said overlay are arrayed around said depressible home keys.

3. The combination according to claim 1 wherein two rows of four said depressible home keys are provided for eight fingers of a typist;
and wherein said two rows of four said depressible home keys are set an oblique angle relative to one another angling away from said typist on its left and right sides;
and wherein said depressions in said overlay are arrayed around said depressible home keys.

4. The combination according to claim 1 wherein a row of four said depressible home keys is provided for four fingers of a typist;
and wherein one depressible home key is provided for one thumb of said typist;
and wherein said depressions in said overlay are arrayed around said depressible home keys.

5. The combination according to claim 1 wherein said overlay can be inflated to provide said at least one depressible home key and to provide an elevated surface surrounding said at least one depressible key and said depressions;
and wherein said overlay can be deflated to lay flat against said proximity touch-sensor layer to provide a continuous flat surface across said proximity touch-sensor layer.

6. The combination according to claim 1 wherein two rows of four said depressible home keys are provided for eight fingers of a typist;
and wherein at least one depressible home key is provided for at least one thumb of said typist;
and wherein said depressions in said overlay are arrayed around said depressible home keys;
and wherein said keyboard is convexly curved with its highest elevation at its center and its lower elevations at its left and right sides;
and wherein a 3D sensor built into said center of said keyboard can track the motion of the fingers of a user in the space above said touch screen for the purpose of providing interactive control in mid-air of a computerized device.

7. The combination according to claim 1 wherein two rows of four said depressible home keys are provided for eight fingers of a typist;
and wherein at least one depressible home key is provided for at least one thumb of said typist;
and wherein said two rows of four said depressible home keys are set an oblique angle relative to one another;
and wherein said depressions in said overlay are arrayed around said depressible home keys;
and wherein said two rows of four said depressible home keys provided for eight fingers of a typist, as well as said depressions in said overlay arrayed around said depressible home keys provided for eight fingers of a typist are spatially separated to make room for a central touch-sensitive surface that is set at a higher elevation than said depressible home keys.

8. The combination according to claim 1 wherein said keyboard is built into a laptop computer within the section of said laptop computer that lies substantially horizontal when said laptop computer is in use.

9. A keyboard for data input including in combination:
a touch screen;
a virtual graphical keyboard displayed on said touch screen;
an overlay that is positioned on top of said touch screen, said overlay preventing engagement of said touch screen by a user's fingers and thumbs where there are no depressions or depressible keys in said overlay;
means for holding said overlay in position over said virtual graphical keyboard;
at least one depressible home key housed within said overlay that must be depressed in order to engage a corresponding area of said touch screen dedicated to the actuation of at least one data input command;
more than one depression in said overlay that allows engagement of said touch screen, each said depression corresponding to an area of said touch screen dedicated to the actuation of at least one data input command;
and
means for coupling said touch screen with a processing device.

10. The combination according to claim 9 wherein said virtual graphical keyboard provides multiple alternate sets of touch-activated characters and commands that can be selected to appear on said virtual graphical keyboard to be used in conjunction with different computerized applications provided by said processing device.

11. The combination according to claim 9 wherein said touch screen and said processing device electronically communicate with at least one other computerized device;
and wherein said virtual graphical keyboard provides multiple alternate sets of touch-activated characters and commands that can be selected to appear on said virtual graphical keyboard to be used to control at least one computerized application being used on said at least one other computerized device.

12. The combination according to claim 9 wherein two rows of four said depressible home keys are provided for eight fingers of a typist;
and wherein at least one depressible home key is provided for at least one thumb of said typist;
and wherein said depressions in said overlay are arrayed around said depressible home keys.

13. The combination according to claim 9 wherein two rows of four said depressible home keys are provided for eight fingers of a typist;
and wherein at least one depressible home key is provided for at least one thumb of said typist;
and wherein said depressions in said overlay are arrayed around said depressible home keys;
and wherein said touch screen is convexly curved with its highest elevation at its center and its lower elevations at its left and right sides.

14. The combination according to claim 9 wherein two rows of four said depressible home keys are provided for eight fingers of a typist;
and wherein said two rows of four said depressible home keys are set an oblique angle relative to one another angling away from said typist on its left and right sides;
and wherein said depressions in said overlay are arrayed around said depressible home keys.

15. The combination according to claim 9 wherein a row of four said depressible home keys is provided for four fingers of a typist;
and wherein one depressible home key is provided for one thumb of said typist;
and wherein said depressions in said overlay are arrayed around said depressible home keys.

16. The combination according to claim 9 wherein said overlay can be inflated to provide said at least one depressible home key and to provide an elevated surface surrounding said at least one depressible key and said depressions;
and wherein said overlay can be deflated to lay flat against said touch screen to provide a continuous flat surface across said touch screen.

17. The combination according to claim 9 wherein said touch screen is housed in a tablet computer;
and wherein said means for holding said overlay in position on said touch screen is a transparent removable cover for said tablet computer that incorporates said overlay.

18. The combination according to claim 9 wherein said touch screen is housed in a smart phone;
and wherein said means for holding said overlay in position on said touch screen is a transparent removable cover for said smart phone that incorporates said overlay.

19. The combination according to claim 9 wherein said means for holding said overlay in position on said touch screen are edge pieces attached to said overlay, said edge pieces formed to reach around the edges of said touch screen to hold said overlay removably in place.

20. The combination according to claim 9 wherein said means for holding said overlay in position on said touch screen is a micro-suction bottom surface incorporated into said overlay.

21. The combination according to claim 9 wherein said touch screen is built into a laptop computer within the section of said laptop computer that lies substantially horizontal when said laptop computer is in use;
and wherein said virtual graphical keyboard provides at least one set of touch-activated characters and commands that can be selected to appear on said virtual graphical keyboard to be used in conjunction with at least one computerized application being used on said laptop computer.

22. The combination according to claim 9 wherein at least one row of four said depressible home keys are provided for four fingers of a typist;
and wherein said depressions in said overlay are arrayed around said depressible home keys;
and wherein one of said depressions is an elongated depression provided for at least one thumb of said typist;
and wherein a thumb of said typist can swipe across said elongated depression to scroll through and select alternate sets of said data input commands that can be selected to appear on said virtual graphical keyboard;
and wherein said alternate sets of said data input commands can be used to engage commands for at least one computerized application provided by one of the following: said processing device, a tablet computer that incorporates said touch screen, a smart phone that incorporates said touch screen, a laptop computer that incorporates said touch screen on its horizontal half, a second computerized device in communication with said processing device.
